(19) United States
(12) Patent Application Publication
(10) Pub. No.: US 2026/0204594 A1
(43) Pub. Date: Jul. 16, 2026

(54) MEMBRANE ELECTRODE ASSEMBLY

(71) Applicant: TOYOTA JIDOSHA KABUSHIKI KAISHA, Toyota-shi (JP)

(72) Inventors: Ryo SHIMIZU, Fuji-shi (JP); Shunsuke TAKAHASHI, Numazu-shi (JP)

(73) Assignee: TOYOTA JIDOSHA KABUSHIKI KAISHA, Toyota-shi (JP)

(21) Appl. No.: 19/437,999

(22) Filed: Dec. 31, 2025

(30) Foreign Application Priority Data
Jan. 16, 2025 (JP) 2025-005859

(51) Int. Cl. H01M 4/86; H01M 4/92; H01M 8/10; H01M 8/1004

(52) U.S. Cl. CPC H01M 4/8663; H01M 4/92; H01M 8/1004; H01M 2008/1095

(57) ABSTRACT

A membrane electrode assembly for a fuel cell includes, in this order, a cathode catalyst layer, a solid polymer electrolyte membrane, and an anode catalyst layer. The cathode catalyst layer contains at least a catalyst and a highly oxygen-permeable ionomer. At least one selected from the group consisting of the cathode catalyst layer, the solid polymer electrolyte membrane, and the anode catalyst layer contains a nitrogen-containing multidentate ligand coordinatable to an iron ion.

### CROSS-REFERENCE TO RELATED APPLICATION

This application claims priority to Japanese Patent Application No. 2025-005859 filed on Jan. 16, 2025. The disclosure of the above-identified application, including the specification, drawings, and claims, is incorporated by reference herein in its entirety.

### BACKGROUND

### 1. Technical Field

The present disclosure relates to membrane electrode assemblies.

### 2. Description of Related Art

Various studies have been conducted on membrane electrode assemblies (MEAs) for fuel cells, such as that disclosed in U.S. Pat. No. 9,172,107.

### SUMMARY

In applying fuel cells to commercial vehicles, improvement of fuel cell durability is a significant challenge. U.S. Pat. No. 9,172,107 discloses that the durability of a fuel cell can be improved by adding a nitrogen-containing multidentate ligand to a membrane electrode assembly. However, the nitrogen-containing multidentate ligand may poison the catalyst in the catalyst layer, which could result in a decrease in the power generation performance of the fuel cell.

The present disclosure has been made in view of the above circumstances, and a primary object thereof is to provide a membrane electrode assembly capable of suppressing a decrease in the power generation performance of a fuel cell.

That is, the present disclosure includes the following aspects.

(1) A membrane electrode assembly for a fuel cell,
the membrane electrode assembly including, in this order, a cathode catalyst layer, a solid polymer electrolyte membrane, and an anode catalyst layer, wherein:
the cathode catalyst layer contains at least a catalyst and a highly oxygen-permeable ionomer; and
at least one selected from the group consisting of the cathode catalyst layer, the solid polymer electrolyte membrane, and the anode catalyst layer contains a nitrogen-containing multidentate ligand coordinatable to an iron ion.

(2) The membrane electrode assembly according to (1), wherein:
the highly oxygen-permeable ionomer is a sulfonyl group-containing polymer;
the sulfonyl group-containing polymer includes a structural unit having a sulfonyl group and a structural unit having a cyclic structure;
the structural unit having the cyclic structure is either or both of a first structural unit having four functional groups and a second structural unit having five functional groups;
in the first structural unit, each of the four functional groups is independently a fluorine atom or a perfluoroalkyl group having one to six carbon atoms; and
in the second structural unit, each of the five functional groups is independently a fluorine atom or a perfluoroalkyl group having one to six carbon atoms.

(3) The membrane electrode assembly according to (1) or (2), wherein the nitrogen-containing multidentate ligand is contained in the anode catalyst layer or the solid polymer electrolyte membrane.

(4) The membrane electrode assembly according to any one of (1) to (3), wherein the catalyst of the cathode catalyst layer includes, as a catalyst metal, at least one selected from the group consisting of platinum particles, platinum alloy particles, and composite particles containing platinum.

(5) The membrane electrode assembly according to any one of (1) to (4), wherein the nitrogen-containing multidentate ligand is 1,10-phenanthroline.

The present disclosure can provide a membrane electrode assembly capable of suppressing a decrease in the power generation performance of a fuel cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a synthesis scheme of Polymer A;

FIG. 2 is a table showing the nitrogen-containing compounds used in the respective anode catalyst layers, the nitrogen-containing compounds used in the respective cathode catalyst layers, and the ionomers used in the respective cathode catalyst layers of Examples 1, 2 and Comparative Examples 1 to 3; and

FIG. 3 is a table showing the initial performance test results and durability test results of the test cells of Examples 1, 2 and Comparative Examples 1 to 3.

### DETAILED DESCRIPTION OF EMBODIMENTS

The present disclosure provides a membrane electrode assembly for a fuel cell.

The membrane electrode assembly includes, in this order, a cathode catalyst layer, a solid polymer electrolyte membrane, and an anode catalyst layer.
The cathode catalyst layer contains at least a catalyst and a highly oxygen-permeable ionomer.
At least one selected from the group consisting of the cathode catalyst layer, the solid polymer electrolyte membrane, and the anode catalyst layer contains a nitrogen-containing multidentate ligand coordinatable to an iron ion.

The following definitions of expressions and terms apply throughout this specification and the claims, unless otherwise specified.

The term “structural unit” refers to a unit derived from a monomer that is formed by radical polymerization of the monomer. A structural unit may be a unit formed directly by the polymerization reaction, or may be a unit in which a portion of the unit has been converted into another structure through treatment of the polymer. Such treatment includes, for example, a treatment that converts a precursor group of an ionic group into an ionic group, an ion-exchange treatment, a treatment of the polymer with hydrogen peroxide, a heat-drying treatment of the polymer in air, in an inert gas atmosphere, or under reduced pressure, a treatment that stabilizes the polymer by fluorination, and a treatment that substitutes hydrogen atoms for iodine atoms by a radical reaction using light or a radical initiator.
The term “monomer” refers to a compound having a polymerizable carbon-carbon double bond.
The term “ionic group” refers to a group having H⁺, a monovalent metal cation, an ammonium ion, or the like.
The term “precursor group” refers to a group that can be converted into an ionic group by a known treatment such as hydrolysis or conversion to acid form. Examples of precursor groups include —SO₂F groups.
The term “fluoropolymer” refers to a polymer having fluorine atoms bonded to carbon atoms.

It is presumed that the decrease in the power generation performance of a fuel cell caused by a nitrogen-containing multidentate ligand is due to the following: nitrogen-containing compounds such as 1,10-phenanthroline, serving as the nitrogen-containing multidentate ligand, flow from either or both of the anode catalyst layer and the solid polymer electrolyte membrane into the cathode catalyst layer, where the nitrogen-containing multidentate ligand poisons the catalyst via the ionomer in the cathode catalyst layer; and the nitrogen-containing multidentate ligand increases the gas diffusion resistance of the ionomer.

By using a highly oxygen-permeable ionomer as the ionomer in the cathode catalyst layer, the present disclosure suppresses catalyst poisoning by the nitrogen-containing multidentate ligand and suppresses a decrease in the power generation performance of a fuel cell. It is presumed that catalyst poisoning by the nitrogen-containing multidentate ligand is suppressed because the cyclic structure of the highly oxygen-permeable ionomer inhibits movement of the nitrogen-containing multidentate ligand within the cathode catalyst layer. Accordingly, the present disclosure improves the durability of a fuel cell through the nitrogen-containing multidentate ligand and improves the power generation performance of a fuel cell through the highly oxygen-permeable ionomer.

The membrane electrode assembly of the present disclosure is for use in a fuel cell.

The membrane electrode assembly includes, in this order, a cathode catalyst layer, a solid polymer electrolyte membrane, and an anode catalyst layer.
The membrane electrode assembly contains a nitrogen-containing multidentate ligand (nitrogen-containing compound) coordinatable to iron ions.
It is sufficient that the nitrogen-containing multidentate ligand is contained in at least one selected from the group consisting of the cathode catalyst layer, the anode catalyst layer, and the solid polymer electrolyte membrane. From the standpoint of suppressing catalyst poisoning in the cathode catalyst layer by the nitrogen-containing multidentate ligand, the nitrogen-containing multidentate ligand may be contained in either or both of the anode catalyst layer and the solid polymer electrolyte membrane, and may be contained in the anode catalyst layer.
The nitrogen-containing multidentate ligand may be any multidentate ligand as long as it can coordinate to iron ions, and examples include those represented by the following formulas (1) to (12).

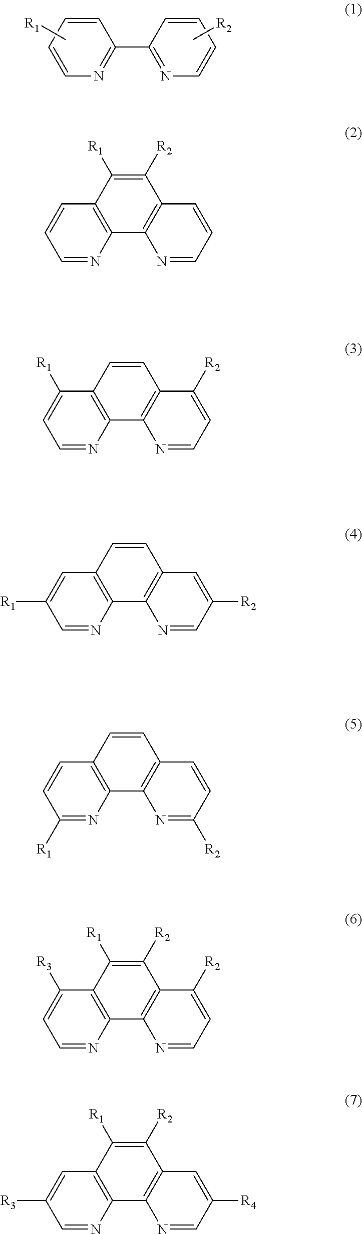

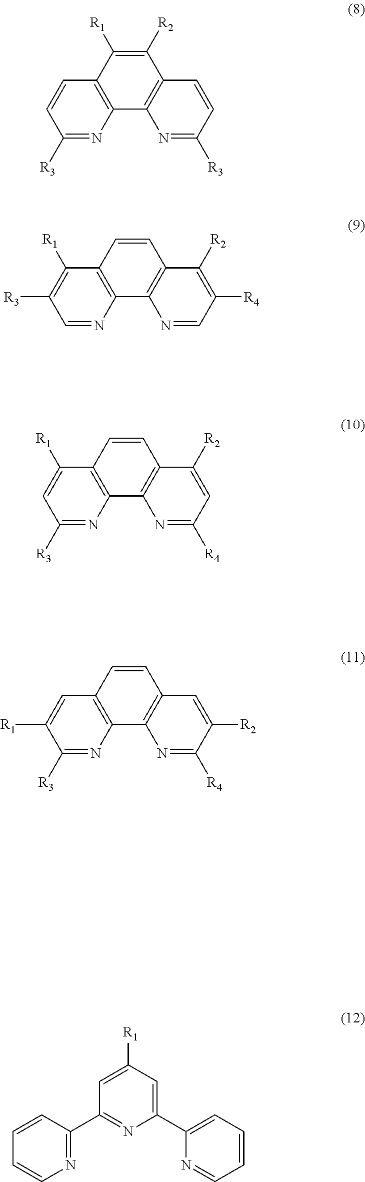

In formulas (1) to (12), R₁, R₃, and R₄ are each independently selected from the group consisting of H, CH₃(CH₂)ₙ, CH₃(CH₂)ₙO, CF₃(CF₂)ₙ, CF₃(CF₂)ₙO, COOH, PO(OH)₂, SO₃H, NH₂, OH, and the following formula (A).

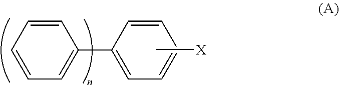

Here, X represents H, COOH, PO(OH)₂, or SO₃H, and n represents an integer from zero to 10. R₂ is selected from the group consisting of CH₃(CH₂)ₙ, CH₃(CH₂)ₙO, CF₃(CF₂)ₙ, CF₃(CF₂)ₙO, COOH, PO(OH)₂, SO₃H, NH₂, OH, and the above formula (A), where X represents H, COOH, PO(OH)₂, or SO₃H, and n represents an integer from zero to 10.

The nitrogen-containing multidentate ligand may be 1,10-phenanthroline.

The cathode catalyst layer contains at least a catalyst and a highly oxygen-permeable ionomer, and may optionally contain the nitrogen-containing multidentate ligand described above.

The content of the nitrogen-containing multidentate ligand in the cathode catalyst layer may be, for example, from 1 μg/cm² to 10 μg/cm². The content of iron ions in the cathode catalyst layer may be, for example, from 0.1 μg/cm² to 2.0 μg/cm².

The highly oxygen-permeable ionomer is a sulfonyl group-containing polymer.

The sulfonyl group-containing polymer includes a structural unit having a sulfonyl group and a structural unit having a cyclic structure.
The structural unit having a cyclic structure constitutes a highly oxygen-permeable portion in the sulfonyl group-containing polymer.
The structural unit having a cyclic structure is either or both of a first structural unit having four functional groups and a second structural unit having five functional groups.
In the first structural unit, each of the four functional groups is independently a fluorine atom or a perfluoroalkyl group having one to six carbon atoms.
In the second structural unit, each of the five functional groups is independently a fluorine atom or a perfluoroalkyl group having one to six carbon atoms.
The structural unit having a cyclic structure may be at least one selected from the structural unit represented by the following formula (u2-1) and the structural unit represented by the following formula (u2-2). In formula (u2-1), R¹ to R⁴ are each independently a fluorine atom or a perfluoroalkyl group having one to six carbon atoms. In formula (u2-2), R⁵ to R¹⁰ are each independently a fluorine atom or a perfluoroalkyl group having one to six carbon atoms.

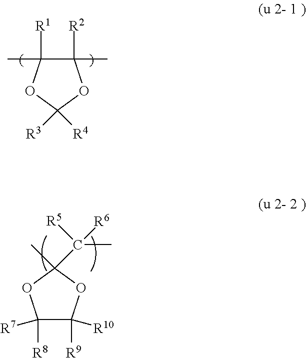

Examples of monomers constituting the structural unit represented by formula (u2-1) include the following monomers (m21-1) to (m21-7). Among these, the monomer (m21-1) may be used because it is highly effective in further improving the oxygen permeability of the sulfonyl group-containing polymer.

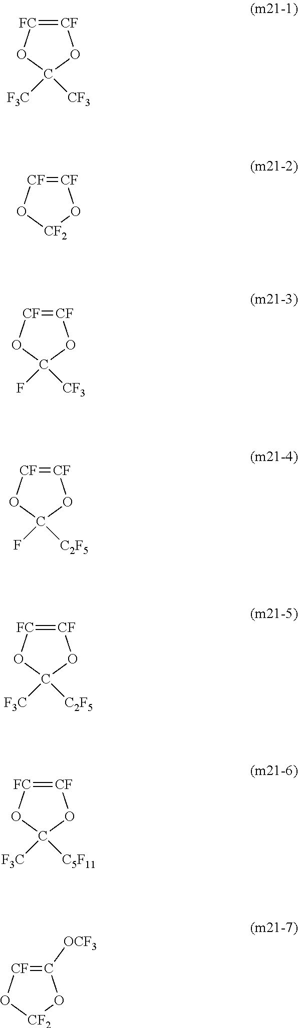

Examples of monomers constituting the structural unit represented by formula (u2-2) include the following monomers (m22-1), (m22-2). Among these, the monomer (m22-1) may be used because of its ease of synthesis.

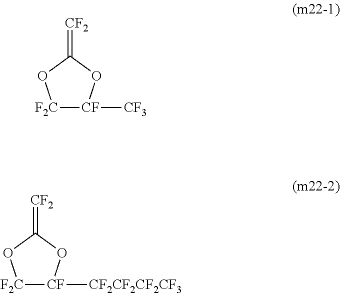

The structural unit having a sulfonyl group may be the structural unit represented by the following formula (u1). In formula (u1), R^{F1} is —(CF₂CF(CF₃O)ₕ—(CF₂)ᵢ—, where h is an integer of zero to three, both inclusive, and i is an integer of one to 10, both inclusive.

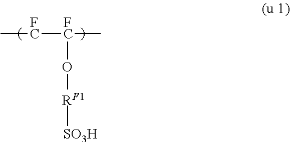

The catalyst contains a catalyst metal.

Examples of the catalyst metal include platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and two or more of these metals may be used in combination. The metal may also be in the form of an oxide, nitride, sulfide, phosphide, or the like.
Among the above, the catalyst metal may be at least one selected from the group consisting of platinum particles, platinum alloy particles, and composite particles containing platinum. The metal other than platinum contained in the platinum alloy and the composite particles containing platinum may be, for example, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium. The platinum alloy or the composite particles containing platinum may contain two or more of these metals.
The elemental ratio of the metal other than platinum in the platinum alloy is not particularly limited, and may be from 0.1 atm % to 50 atm %.
The particle size (average particle size) of the catalyst metal particles is not particularly limited, and may be from 1 nm to 100 nm.

In the present disclosure, the average particle size of the particles is determined by measuring the particle sizes of 100 to 1000 particles with an electron microscope and taking their average value as the average particle size.

The catalyst may include a support (carrier).

The catalyst metal may be supported on the support.
The average particle size of the primary particles of the support may be, for example, from 5 nm to 500 nm.
The metal loading ratio of the catalyst metal on the support is not particularly limited, and may be from 1% to 60%, or may be from 18% to 48%.
The support may be conductive carbon, an oxide, or the like.
The carbon may be carbon black (such as acetylene black, Ketjen black, or furnace black), activated carbon, carbon graphite, glassy carbon, graphite, graphene, carbon fibers, carbon nanotubes, carbon nitride, carbon sulfide, carbon phosphide, or a mixture containing at least two of these.
The oxide may be titanium oxide, niobium oxide, tin oxide, tungsten oxide, molybdenum oxide, or a mixture containing at least two of these.
In the cathode catalyst layer, the mass ratio (I/C) of the highly oxygen-permeable ionomer to the carbon serving as the support in the catalyst may be from 0.8 to 1.2.

The catalyst may include an ionomer.

The ionomer may be a polymer that exchanges ions, and the ion-exchange group may be an acidic functional group. The acidic functional group may be, for example, a sulfonic acid group or a phosphoric acid group. The ionomer may be a perfluorocarbon sulfonic acid polymer, an anion exchange polymer, or a polymer with polyether ether ketone or polybenzimidazole as its main component. The ionomer may be the highly oxygen-permeable ionomer described above.

Methods for evaluating the weight of the catalyst metal, the weight of the support, and the weight of the ionomer contained in the catalyst include thermogravimetric (TG) analysis and inductively coupled plasma (ICP) emission spectroscopy.

The anode catalyst layer contains at least a catalyst and an ionomer, and may optionally contain the nitrogen-containing multidentate ligand described above.

The content of the nitrogen-containing multidentate ligand in the anode catalyst layer may be, for example, from 1 μg/cm² to 10 μg/cm². The content of iron ions in the anode catalyst layer may be, for example, from 0.1 μg/cm² to 2.0 μg/cm².
The catalyst contained in the anode catalyst layer may be the same as, or different from, the catalyst contained in the cathode catalyst layer described above.
The ionomer may be the highly oxygen-permeable ionomer described above, or may be an ionomer other than the highly oxygen-permeable ionomer. Examples of ionomers other than the highly oxygen-permeable ionomer include the same ionomers as those contained in the catalyst described above.
In the anode catalyst layer, the mass ratio (I/C) of the ionomer to the carbon serving as the support may be from 0.8 to 1.2.

Examples of the solid polymer electrolyte membrane include fluorine-based electrolyte membranes such as thin perfluorosulfonic acid membranes containing water, and hydrocarbon-based electrolyte membranes. The solid polymer electrolyte membrane may be, for example, a Nafion (registered trademark) membrane (manufactured by DuPont).

The solid polymer electrolyte membrane may optionally contain the nitrogen-containing multidentate ligand described above.
The content of the nitrogen-containing multidentate ligand in the solid polymer electrolyte membrane may be, for example, from 1 μg/cm² to 10 μg/cm². The content of iron ions in the solid polymer electrolyte membrane may be, for example, from 0.1 μg/cm² to 2.0 μg/cm².

### Method for Forming Catalyst Layer

Examples of methods for forming the catalyst layer include a method in which the catalyst layer is formed through a catalyst ink preparation step and a catalyst ink coating step described below.

### Catalyst Ink Preparation Step

First, a support loaded with a catalyst metal (catalyst metal-loaded support), a highly oxygen-permeable ionomer or an ionomer other than the highly oxygen-permeable ionomer, a solvent, and optionally, a nitrogen-containing compound are placed in predetermined amounts into a vessel, and stirred with a stirrer to prepare a catalyst ink.

The type of solvent is not particularly limited, and any liquid can be used. Examples include water, alcohols, and mixed solutions of at least one alcohol and water.
Examples of alcohols include methanol, diacetone alcohol, ethanol, 1-propanol, 2-propanol, tert-butyl alcohol, ethylene glycol, and propylene glycol.
Examples of stirrers include an ultrasonic homogenizer, a jet mill, a bead mill, a ball mill, a high-shear mixer, and a FILMIX. The stirring conditions such as stirring speed, stirring time, and rotational speed are not particularly limited and may be set as appropriate.
Thereafter, vacuum degassing may be performed. The standing time is not particularly limited and may be set as desired. For example, the catalyst ink may be allowed to stand for one day. Alternatively, the catalyst ink may be used without being allowed to stand. Vacuum degassing may be performed again.

### Catalyst Ink Coating Step

A substrate is coated with the prepared catalyst ink, and the solvent is removed after coating. For example, a substrate such as polytetrafluoroethylene (PTFE) is coated with the catalyst ink, and the catalyst ink may then be heated to dry and remove the solvent.

Any coating method may be used as long as the substrate can be uniformly coated with the catalyst ink. Examples include die coating, spin coating, screen printing, doctor blade coating, squeegee coating, spray coating, and applicator coating. The heating rate and the heating time may be set as appropriate depending on the type of solvent or the like. The removal rate may be increased by performing degassing simultaneously with heating. The thickness of the coating film may be from 5 m to 30 m. The substrate may be coated with the catalyst ink such that the amount of platinum in the coating film is from 0.1 mg/cm² to 0.6 mg/cm².

### Synthesis of Highly Oxygen-Permeable Ionomer

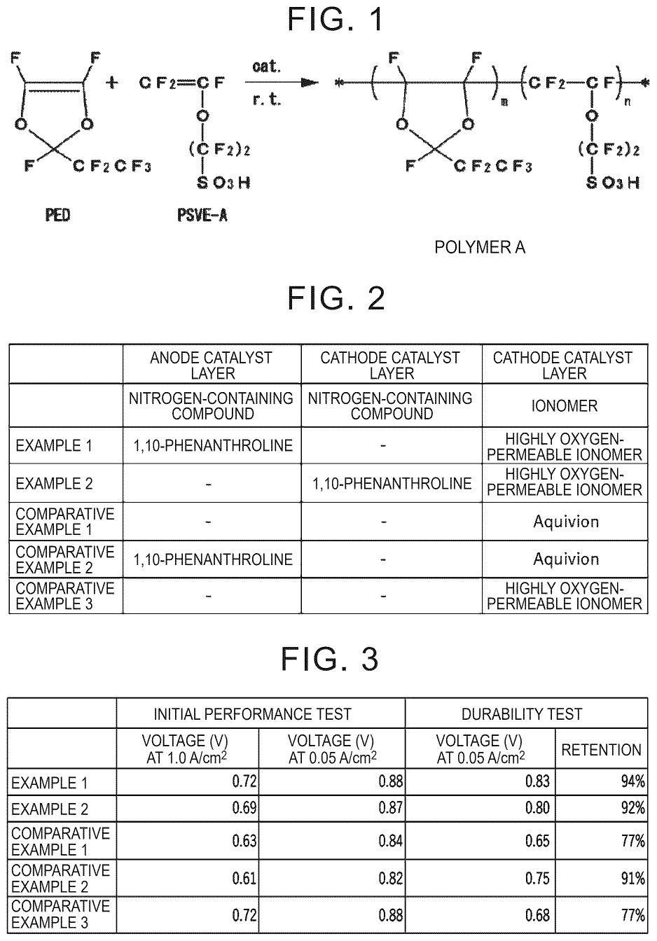

With reference to Japanese Unexamined Patent Application Publication No. 2013-216811 (JP 2013-216811 A) and Macromolecules 1993, 26, 5829-5843, Polymer A, which is a highly oxygen-permeable ionomer, was synthesized by the synthesis scheme of Polymer A shown in FIG. 1 using perfluoro(2-ethyl-1,3-dioxole) (PED) that constitutes the highly oxygen-permeable portion.

### Synthesis of Polymer A

PED (5.07 g) and perfluorosulfonyl fluoride vinyl ether (PSVE-A) (28.79 g) were mixed. The molar ratio of PED to PSVE-A was set to PED:PSVE-A=0.74:0.26. Thereafter, 0.05 mol % of a polymerization initiator was added to the mixture. The resulting mixture was subjected to three cycles of freeze-pump-thaw and nitrogen purging, and then allowed to react at room temperature for two days. The mixture was then heated at 120° C. for one hour under vacuum to remove unreacted monomers. As a result, 7.0 g of the desired highly oxygen-permeable ionomer (Polymer A) was obtained.

The ion exchange capacity of Polymer A at this time was 810. The ion exchange capacity of Polymer A was calculated by the following method.

### Ion Exchange Capacity of Fluoropolymer (Polymer A)

First, 1.0 g of Polymer A and 10 mL of a water/methanol mixed solution containing sodium hydroxide at a concentration of 0.35 N were placed in a polycarbonate vessel, and the resulting solution was allowed to stand at 60° C. for 40 hours to convert the —SO₂F groups of Polymer A into —SO₃Na groups. A back titration of the solution was performed with 0.1 N hydrochloric acid using phenolphthalein as an indicator, and the ion exchange capacity of the —SO₃H form of Polymer A was calculated from the amount of sodium hydroxide present in the solution. The ion exchange capacity at this time was taken as the ion exchange capacity of Polymer A.

### Examples 1, 2, Comparative Examples 1 to 3

### Preparation of Cathode Catalyst Layer

A platinum-loaded carbon catalyst having a peak pore diameter of 3.5 nm, a mesopore volume of 14.0 cc/g in the range from 2 nm to 30 nm, and a Brunauer-Emmett-Teller (BET) specific surface area of 708.0 m²/g was used as the catalyst particles constituting the cathode catalyst layer.

As the ionomer solution, Aquivion (registered trademark) D79-25BS (manufactured by Sigma-Aldrich) was used in Comparative Examples 1, 2. An ionomer solution containing Polymer A, which is a highly oxygen-permeable ionomer, water, and ethanol was used in Example 1 and Comparative Example 3. An ionomer solution containing Polymer A, which is a highly oxygen-permeable ionomer, 1,10-phenanthroline as a nitrogen-containing compound, water, and ethanol was used in Example 2.
The catalyst particles were dispersed in the ionomer solutions of Examples 1, 2 and Comparative Examples 1 to 3 using a bead mill to prepare the catalyst inks of Examples 1, 2 and Comparative Examples 1 to 3.

In the catalyst inks of Examples 1, 2 and Comparative Examples 1 to 3, the mass ratio of water to alcohol was set to 1. A polytetrafluoroethylene sheet was coated with each catalyst ink and dried to prepare the cathode catalyst layers.

In Example 2, the content of the nitrogen-containing compound in the cathode catalyst layer was set to 6 μg/cm², and the content of iron ions in the cathode catalyst layer was set to 1.0 μg/cm².
In Examples 1, 2 and Comparative Examples 1 to 3, the platinum loading of the cathode catalyst layer was set to 0.2 mg/cm².
In Examples 1, 2 and Comparative Examples 1 to 3, the mass ratio (I/C) of the ionomer to the carbon in the cathode catalyst layer was set to 1.0.

### Preparation of Anode Catalyst Layer

Platinum-loaded carbon catalyst particles (TEC10E30E, 30% platinum-loaded carbon, manufactured by Tanaka Precious Metal Technologies Co., Ltd.) were used as the catalyst.

An ionomer solution containing water, ethanol, an aqueous ferric nitrate solution, and 1,10-phenanthroline as a nitrogen-containing compound was used in Example 1 and Comparative Example 2.
An ionomer solution containing water, ethanol, and an aqueous ferric nitrate solution was used in Example 2 and Comparative Examples 1, 3.
The platinum-loaded carbon catalyst particles were dispersed in the ionomer solutions of Examples 1, 2 and Comparative Examples 1 to 3 using a bead mill to prepare the catalyst inks of Examples 1, 2 and Comparative Examples 1 to 3. A polytetrafluoroethylene sheet was coated with each catalyst ink and dried to prepare the anode catalyst layers of Examples 1, 2 and Comparative Examples 1 to 3.
In Examples 1, 2, the content of the nitrogen-containing compound in the anode catalyst layer was set to 6 μg/cm², and the content of iron ions in the anode catalyst layer was set to 1.0 μg/cm².
In Examples 1, 2 and Comparative Examples 1 to 3, the platinum loading of the anode catalyst layer was set to 0.1 mg/cm².
In Examples 1, 2 and Comparative Examples 1 to 3, the mass ratio (I/C) of the ionomer to the carbon in the anode catalyst layer was set to 1.0.

### Preparation of MEA

The cathode catalyst layers and anode catalyst layers of Examples 1, 2 and Comparative Examples 1 to 3 were hot-pressed onto both sides of a Nafion (registered trademark) membrane (NR211) to prepare membrane electrode assemblies (MEAs) of Examples 1, 2 and Comparative Examples 1 to 3. The hot-pressing conditions were 140° C., 50 kgf/cm² (4.90 MPa), and five minutes. The electrode area was set to 1 cm×1 cm (1 cm²) for performance evaluation and 3.6 cm×3.6 cm (12.96 cm²) for durability evaluation. Each MEA was sandwiched between gas diffusion layers (GDLs) with a water-repellent layer to prepare the test cells (cells) of Examples 1, 2 and Comparative Examples 1 to 3.

FIG. 2 is a table showing the nitrogen-containing compounds used in the respective anode catalyst layers, the nitrogen-containing compounds used in the respective cathode catalyst layers, and the ionomers used in the respective cathode catalyst layers of Examples 1, 2 and Comparative Examples 1 to 3.

### Initial Performance Evaluation

Cell evaluation was carried out using the test cells respectively including the membrane electrode assemblies (electrode area: 12.96 cm²) of Examples 1, 2 and Comparative Examples 1 to 3. Under low-humidity conditions (cell temperature: 80° C., humidity: 30% relative humidity (RH)), the current-voltage characteristics were evaluated, and the performance (voltage) at 1.0 A/cm² and 0.05 A/cm² was measured. The sweep rate for evaluating the current-voltage characteristics was set to 20 mA/s, and the data were acquired while sweeping the anode. The cell pressure was set to 150 kPa, the anode gas was hydrogen, the anode gas flow rate was set to 1.0 L/min, the cathode gas was air, and the cathode gas flow rate was set to 2.0 L/min. The results are shown in FIG. 3.

### High-Potential Holding Test

A durability test was conducted for 300 hours using the test cells (electrode area: 12.96 cm²) of Examples 1, 2 and Comparative Examples 1 to 3 in a low-humidity environment (cell temperature: 95° C., humidity: 30% RH) at a low current density (0.2 A/cm²), that is, under conditions in which degradation of the electrolyte membrane is likely to occur. The cell pressure was set to 150 kPa, the anode gas was hydrogen, the anode gas flow rate was set to 1.0 L/min, the cathode gas was air, and the cathode gas flow rate was set to 2.0 L/min. After the durability test, hydrogen and air were supplied, and the characteristics of the polymer electrolyte fuel cell at a current density of 0.05 A/cm² were evaluated under the same conditions as those in the initial performance test described above. The retention of the cell voltage after a predetermined operating time relative to the initial cell voltage ((cell voltage at 0.05 A/cm² after durability test/cell voltage at 0.05 A/cm² at initial performance evaluation)×100)) was measured. The results are shown in FIG. 3.

### Evaluation Results

FIG. 3 is a table showing the initial performance test results and durability test results of the test cells of Examples 1, 2 and Comparative Examples 1 to 3.

As shown in FIG. 3, the cells of Examples 1, 2 exhibited higher voltages at both 1.0 A/cm² and 0.05 A/cm² in the initial performance test, compared to Comparative Examples 1 to 3. As shown in FIG. 3, it was found that the cells of Examples 1, 2 exhibited a smaller change in voltage (i.e., higher performance retention) at 0.05 A/cm² relative to the initial value after the durability test, compared to Comparative Examples 1 to 3.

What is claimed is:

1. A membrane electrode assembly for a fuel cell, the membrane electrode assembly comprising, in following order:
a cathode catalyst layer;
a solid polymer electrolyte membrane; and
an anode catalyst layer, wherein:
the cathode catalyst layer contains at least a catalyst and a highly oxygen-permeable ionomer; and
at least one selected from the group consisting of the cathode catalyst layer, the solid polymer electrolyte membrane, and the anode catalyst layer contains a nitrogen-containing multidentate ligand coordinatable to an iron ion.

2. The membrane electrode assembly according to claim 1, wherein:
the highly oxygen-permeable ionomer is a sulfonyl group-containing polymer;
the sulfonyl group-containing polymer includes a structural unit having a sulfonyl group and a structural unit having a cyclic structure;
the structural unit having the cyclic structure is either or both of a first structural unit having four functional groups and a second structural unit having five functional groups;
in the first structural unit, each of the four functional groups is independently a fluorine atom or a perfluoroalkyl group having one to six carbon atoms; and
in the second structural unit, each of the five functional groups is independently a fluorine atom or a perfluoroalkyl group having one to six carbon atoms.

3. The membrane electrode assembly according to claim 1, wherein the nitrogen-containing multidentate ligand is contained in the anode catalyst layer or the solid polymer electrolyte membrane.

4. The membrane electrode assembly according to claim 1, wherein the catalyst of the cathode catalyst layer includes, as a catalyst metal, at least one selected from the group consisting of platinum particles, platinum alloy particles, and composite particles containing platinum.

5. The membrane electrode assembly according to claim 1, wherein the nitrogen-containing multidentate ligand is 1,10-phenanthroline.
